(19) United States
(12) Patent Application Publication
(10) Pub. No.: US 2013/0269635 A1
(43) Pub. Date: Oct. 17, 2013

(54) Heat Exchange Medium

(71) Applicants: Mats Arrhenborg, Stockholm (SE); Stefan Lindstrom, Indal (SE)

(72) Inventors: Mats Arrhenborg, Stockholm (SE); Stefan Lindstrom, Indal (SE)

(73) Assignee: EC1 INVENT AB, Indal (SE)

(21) Appl. No.: 13/699,933

(22) PCT Filed: Dec. 16, 2010
(86) PCT No.: PCT/SE2010/051393

§ 371 Date: Jun. 27, 2013

(30) Foreign Application Priority Data
May 25, 2010 (SE) 1050518-8

(51) Int. Cl. C09K 5/10; F01P 3/00

(52) U.S. Cl. CPC C09K 5/10; F01P 3/00
USPC 123/41.42; 252/73

(57) ABSTRACT

The present invention relates to the replacement of water and glycol mixtures by a synthetically made diesel as cooling medium, for instance engine coolant in vehicles. The synthetic diesel is environmental-friendly, usable in a wide temperature range, functions as corrosion protection in radiator systems, and transports heat better than water does.

The present invention relates generally to a heat exchange medium for the transfer of heat or cold from another medium. An example of such a heat exchange medium is engine coolant for vehicles.

### BACKGROUND

Today's motorcar engines, irrespective of engine fuel, are cooled by water. In order to avoid that the water freezes at low temperatures, glycol is often added. The glycol has also a function of providing corrosion protection to the radiator structure. At a mixture of approx. 50% of water and approx. 50% of glycol, the composition generally gets a freezing point around −40° C. and a boiling point just above 100° C. Therefore, there is a risk of the cooling water beginning to boil at high temperatures, for instance in hot days. If the composition is changed to 60% of glycol and 40% of water, the freezing point falls to approx. −45° C. However, at an even higher content of glycol, the freezing point rises again.

A disadvantage of glycol is that it is poisonous, and in the case of ethylene glycol, it may even be lethal. There is also a risk of the cooling water containing glycol freezing, above all at a lower content of glycol or percentages of glycol above 60%. Glycol may also degrade over time and then loses some of the properties thereof. Therefore, the engine coolant needs to be exchanged now and then.

Therefore, there is a need of finding an alternative cooling medium that overcomes the disadvantages above and that can replace water containing glycol for the cooling of, for instance, engines in vehicles.

It is also known to use a number of different oils for the cooling in a range of different systems. However, these oils are not suitable to use in, for instance, the cooling of engines in vehicles. Previously, tests have also been made with ethanol-water mixtures, which however tend to evaporate.

It has been reported that the German army during the Second World War employed diesel oil as engine coolant in order to prevent that the engine coolant froze at low temperatures. However, the diesel oil presented problems in that it destroyed gaskets, etc., in the cooling system and caused problems with corrosion in the system as a consequence of moisture and dirt being mixed with the diesel oil, which made it acidic.

### SUMMARY

The object of the present invention is to find a heat exchange medium, such as a cooling medium, which can replace water and its mixtures with glycol for the cooling of, for instance, engines.

This is attained by the cooling medium according to claim 1. Preferred embodiments are defined in the dependent claims. The object is also attained by the use of a synthetic diesel in accordance with claim 6 and a heat exchange system in accordance with claim 9.

In accordance with the present invention, water and glycol are replaced by a synthetically made diesel. The diesel that is used should basically be free from polycyclic alkanes and aromatic hydrocarbons. Accordingly, the synthetic diesel has a composition that comprises non-cyclic alkanes at a percentage of at least 50%, possibly up to 50% of alkylated monocyclic alkanes, not more than 1% of aromatic hydrocarbons, and not more than 1% of di- and polycyclic alkanes. All percentages are given in percent by weight. This synthetic diesel is as such previously known for use as engine fuel for diesel engines in different vehicles, above all vehicles in environments where it is important to minimize exhaust fumes, such as in mines and warehouses.

In accordance with an embodiment of the invention, the synthetic diesel comprises at least 65% of non-cyclic alkanes. Preferably, it contains not less than 70% of non-cyclic alkanes. Since the diesel is not to be combusted, it does not need to contain energy-boosting compounds, such as alkylated monocyclic alkanes. If anything, it is advantageous to minimize the percentage of these in order to, in such a way, further decrease the flammability of the diesel. According to a preferred embodiment, therefore, the percentage of alkylated monocyclic alkanes is preferably not more than 25%, more preferably not more than 10%.

In accordance with a further embodiment of the invention, the synthetic diesel comprises at most 0.5% of aromatic hydrocarbons and/or at most 0.5% of polycyclic alkanes.

The synthetic diesel is difficult to ignite. However, it is possible to add a fire-resistant additive if desired, since it is to be used as heat exchange medium such as a cooling medium. Examples of fire-resistant additives are boric acid and boron salt.

It is also possible to add a colouring agent to the heat exchange medium in order to, in such a way, make it easy to distinguish it from other liquids. For example, when the heat exchange medium is an engine coolant for vehicles, it may be given a colour that differs from, for instance, windscreen washer fluid, other types of engine coolants, etc., in order to avoid mistaking it for these liquids.

### DETAILED DESCRIPTION

The present invention is based on the finding that it is possible to replace water and glycol mixtures by a clean synthetic diesel as cooling medium and thereby allow cooling in a wider temperature range, as well as to overcome the problem that glycol is poisonous.

Conventional diesel, produced for instance from petroleum, contains a lot of different residual substances. It is these residual substances that make the diesel harmful to the environment and that the diesel may risk knocking out entire ecosystems, e.g., in seas or lakes. Even if conventional diesel could function as cooling medium, it is not directly suitable because of several reasons. In the first place, conventional diesel is not environmental-friendly and accordingly represents an increased environmental risk. In addition, the conventional diesel may run the risk of being decomposed if water and dirt enter and thereby cause corrosion in the cooling system. In addition, it contains volatile hydrocarbons, which may constitute a health risk. Furthermore, in certain cases it may run the risk of being ignited upon, for instance, a collision of a vehicle.

In accordance with the present invention, therefore, a synthetically made diesel is used, which is essentially free from the impurities that may make the diesel harmful to the environment and make it running the risk of becoming ignitable. It is an essential part of the invention that the diesel is basically clean, in order for it to be suitable as cooling medium or another type of heat exchange medium.

The synthetic diesel has a much higher boiling point than mixtures of water and glycol, more precisely at least above 200° C., and can therefore be used at a much higher temperature than water with glycol. In addition, its freezing point is approx. −40° C., which makes it usable also in very cold climates. Accordingly, the synthetic diesel allows the use in a wider temperature range than water and glycol mixtures. For instance, the synthetic diesel functions very well as engine coolant in vehicles operating at high temperatures, for instance very hot days and under the exposure of the sun.

Furthermore, the synthetic diesel is very difficult to ignite, and can therefore easily replace different water mixtures in cooling systems in vehicles without risking fire or explosion upon a possible collision or the like.

The synthetic diesel has also the ability to reduce corrosion, for instance, in cooling ducts in engines and heating systems, and has a lubricating effect on the pump that should circulate the cooling medium. This, in turn, gives an extended service life of other parts of cooling and heating systems.

In addition, the synthetic diesel is not evaporated and therefore does not need to be refilled in a heat transfer system, such as a radiator of a vehicle, in the same way as for conventional cooling media. It is neither poisonous nor in another way hazardous to the environment or the user, unlike, for instance, glycol.

Furthermore, the synthetic diesel has a better heat transfer capacity than water, which allows more efficient heat transfer systems.

The synthetic diesel can easily be made by means of conventional processes, such as the Fischer-Tropsch process, either from biomass or from gas. It is also feasible that the synthetic diesel can be made from coal. By means of the Fischer-Tropsch process, it is possible to make synthetic diesel that is basically free from aromatic hydrocarbons, polyaromatic hydrocarbons (PAH) and sulphur, and accordingly is very clean. Because of the very low percentages of residual substances, the synthetic diesel is no longer poisonous and is even biodegradable. Furthermore, the synthetic diesel is very difficult to ignite and in principle free from smell.

The synthetic diesel is particularly suitable for use as heat exchange medium in heat exchange systems, i.e., the medium that transfers heat or cold to another medium. It is also suitable as cooling medium, above all as a substitute in systems that today use water and glycol mixtures. A specific example of a suitable field of application is as engine coolant in vehicles, such as cars, boats, tractors, lorries/trucks, buses, etc.

Use of the synthetic diesel in cooling systems of the diesel engines is particularly advantageous, since the synthetic diesel has a lubricating effect on the cooling system. In addition, the risk of significant damage upon leakage of engine fuel into the radiator system is eliminated, which may cause devastating effects when water and glycol are used as cooling medium. However, when using a synthetic diesel as engine coolant, there is no risk of damage upon leakage of engine fuel into the system, since the engine coolant and the engine fuel are compatible with each other. Furthermore, a possible leakage of engine coolant into the lubricating system of the engine does not represent any risk of damage, since the engine coolant is compatible with other media in the lubricating system. Since the diesel is so clean, neither does it risk corroding gaskets and the like in the cooling system.

Even if the present invention primarily has been described with reference to the cooling of engines in vehicles, it should be appreciated that the invention is not limited to this application. It is also possible to use it as cooling medium in all types of engines that today are water-cooled. It is also feasible to use it as heat exchange medium in heating and cooling system in houses and industries. The synthetic diesel is also feasible to use as cooling medium for the cooling of tools, such as milling cutters, drills, turning lathes, etc.

1. Cooling medium, characterized in that it basically consists of a synthetic diesel comprising non-cyclic alkanes at a percentage of at least 50%, possibly up to 50% of alkylated monocyclic alkanes, not more than 1% of aromatic hydrocarbons, and not more than 1% of di- and polycyclic alkanes.

2. Cooling medium according to claim 1, characterized in that the synthetic diesel contains at least 65% of non-cyclic alkanes, preferably not less than 70% of non-cyclic alkanes.

3. Cooling medium according to claim 1, characterized in that the synthetic diesel contains at most 0.5% of aromatic hydrocarbons.

4. Cooling medium according to claim 1, characterized in that the synthetic diesel contains at most 0.5% of polycyclic alkanes.

5. Cooling medium according to claim 1, characterized in that it also contains a fire-resistant additive.

6. Use of a synthetic diesel comprising non-cyclic alkanes at a percentage of at least 50%, possibly up to 50% of alkylated monocyclic alkanes, not more than 1% of aromatic hydrocarbons, and not more than 1% of di- and polycyclic alkanes, as heat exchange medium.

7. Use of a synthetic diesel according to claim 6, the heat exchange medium being a cooling medium.

8. Use of a synthetic diesel according to claim 6 as engine coolant in vehicles.

9. Heat exchange system comprising a device intended for heat exchange, said device being adapted to contain a liquid medium for heat exchange, characterized in that said medium for heat exchange is a synthetic diesel comprising non-cyclic alkanes at a percentage of at least 50%, possibly up to 50% of alkylated monocyclic alkanes, not more than 1% of aromatic hydrocarbons, and not more than 1% of di- and polycyclic alkanes.
